(19) United States
(12) Patent Application Publication
(10) Pub. No.: US 2006/0107846 A1
(43) Pub. Date: May 25, 2006

(54) Apparatus for making rolled food product

(76) Inventors: Gilbert M. Foulon JR., Wanaque, NJ (US); John C. Walz, Bloomfield, NJ (US); Kenneth L. Schmidt, Succasunna, NJ (US); Thomas G. Berger, Ridgefield, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/261,049

(22) Filed: Oct. 28, 2005

Related U.S. Application Data
(60) Provisional application No. 60/623,572, filed on Oct. 29, 2004.

(51) Int. Cl. A23P 1/00

(52) U.S. Cl. 99/450.1

(57) ABSTRACT

The present invention relates to apparatus for making rolled food products. More particularly, the apparatus includes a dispensing mechanism for dispensing edible filling materials onto a generally planar shell and a rolling mechanism for making the shell dispensed with the filling materials into a roll.

### CROSS-REFERENCE TO RELATED APPLICATION

This application claims the benefit of U.S. Provisional Patent Application No. 60/623,572 filed Oct. 29, 2004, the disclosure of which is incorporated herein by reference in its entirety.

### FIELD OF THE INVENTION

The present invention relates to apparatus for making rolled food products and, more particularly, to apparatus for filling and rolling food products.

### BACKGROUND OF THE INVENTION

In the past, various machines have been developed for making food products. While some of these machines are adapted for folding shells so as to form folded food products, such as folded sandwiches, egg rolls, burritos, etc. (see, for instance, U.S. Pat. No. 5,912,035), they are not generally useful in making rolled food products, such as taquitos. In such circumstances, there is a need for a machine for making rolled food products.

### SUMMARY OF THE INVENTION

The present invention overcomes the disadvantages and shortcomings of the prior art discussed above by providing a new and improved apparatus for making rolled food products. More particularly, the apparatus includes a dispensing mechanism for dispensing edible filling materials onto a generally planar shell and a rolling mechanism for making the shell dispensed with the filling materials into a roll. The apparatus is also provided with a supporting structure having upstream and downstream ends. The dispensing mechanism includes a dispensing nozzle positioned on the supporting structure between the upstream and downstream ends. At least one conveyor belt is positioned on said supporting structure for moving a shell placed thereon toward said downstream end. The rolling mechanism includes a bias belt positioned above said at least one conveyor belt for rolling a shell placed between said bias belt and said at least one conveyor.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a perspective view of a machine constructed in accordance with the present invention for forming a rolled food product, such as a taquito;

FIG. 2 is a view similar to FIG. 1, except that a bias-rolling conveyor assembly of the machine is shown disassembled therefrom;

FIG. 3 is a view similar to FIG. 2, except that a take-away conveyor assembly of the machine is shown disassembled therefrom;

FIG. 4 is a top plan view of the machine shown in FIG. 1;

FIG. 4A is an enlarged view of an upstream portion of the machine shown in FIG. 4;

FIG. 5 is a side elevational view of the machine shown in FIG. 1;

FIG. 6 is a partially broken-away perspective view of a vacuum conveyor assembly of the machine shown in FIG. 1;

FIG. 7 is a perspective view of an upstream end and a filling and folding area of the machine shown in FIG. 1;

FIG. 8A is a perspective view of a plow of the machine shown in FIG. 1;

FIG. 8B is a top plan view of the plow shown in FIG. 8A;

FIG. 8C is a view of the plow shown in FIG. 8A, looking from below;

FIG. 8D is a side elevational view of the plow shown in FIG. 8A;

FIG. 8E is a front elevational view of the plow shown in FIG. 8A;

FIG. 9A is a perspective view of the upstream end of the machine shown in FIG. 1, a shell being placed on the vacuum conveyor assembly;

FIG. 9B is a view similar to FIG. 9A, except that the shell is advanced to an adhesive-spraying area of the machine by the vacuum conveyor assembly;

FIGS. 10A-10F are schematic perspective views of the filling and folding area of the machine as the shell shown in FIG. 9B is advanced therethrough for filling and folding operations;

FIGS. 11A-11C are schematic views of the shell as it is rolled by a bias-rolling belt of the machine shown in FIG. 1;

FIG. 12 is a block diagram of a control system utilized in the machine of in FIG. 1 for controlling the operation of same;

FIG. 13 is a front perspective view of a modified version of the machine of FIG. 1 having a pivotally mounted bias-rolling conveyor assembly;

FIG. 14 is a view similar to FIG. 13, except that the bias-rolling conveyor assembly is in its upwardly pivoted position;

FIG. 15 is a lateral perspective view of the modified machine shown in FIG. 14; and

FIG. 16 is an enlarged perspective view of a section of the modified machine shown in FIG. 14.

### DETAILED DESCRIPTION OF THE INVENTION

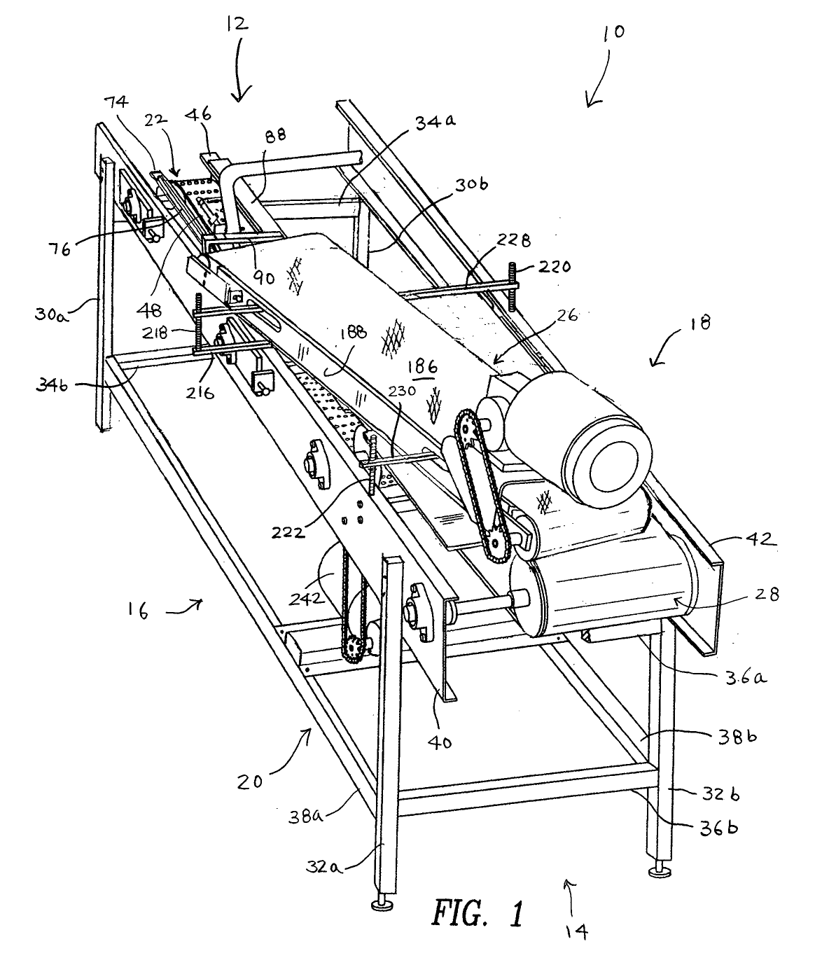

FIG. 1 shows a machine 10 constructed in accordance with the present invention for making rolled food products, such as taquitos. The machine 10 includes an upstream or proximal end 12 and a downstream or distal end 14 opposite the upstream end 12, as well as a pair of lateral sides 16, 18. The machine 10 is adapted to receive individual sheets or shells of covering material, such as flexible tortilla sheets or shells (referred to hereinafter as “shells”), at the upstream end 12 and to transport them to the downstream end 14. As individual shells are transported from the upstream end 12 to the downstream end 14, they are filled with filling materials and then rolled into rolled food products (e.g., taquitos) by the machine 10. To facilitate consideration and discussion, various components of the machine 10 will be described briefly hereinbelow, followed by a detailed description of the machine 10.

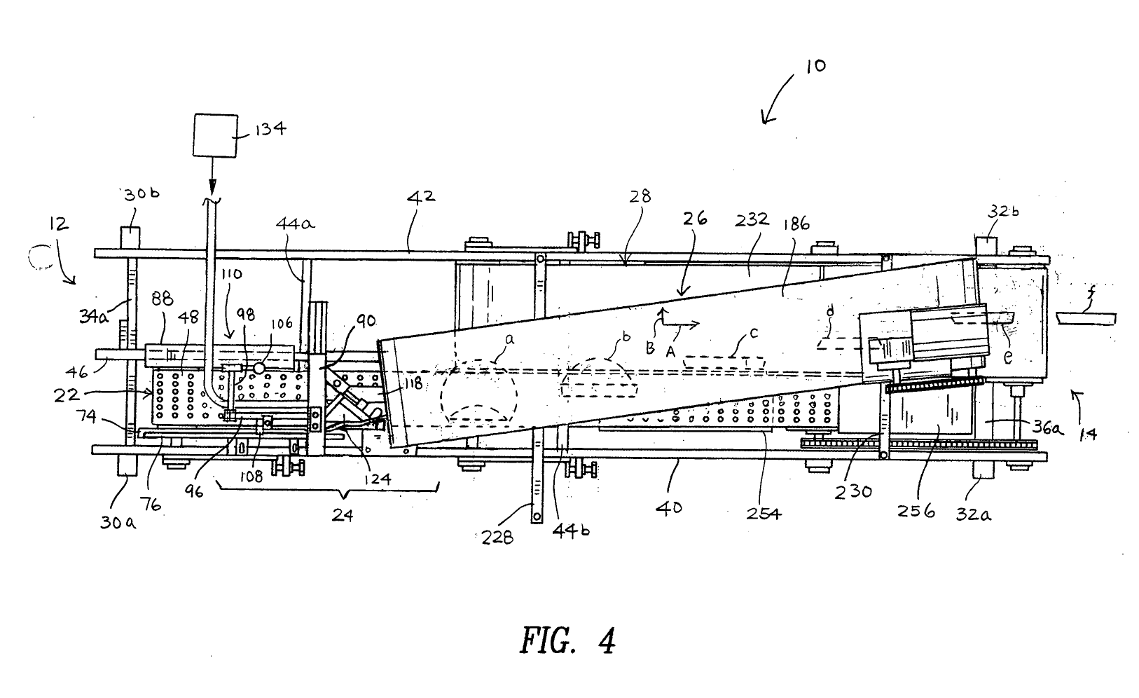

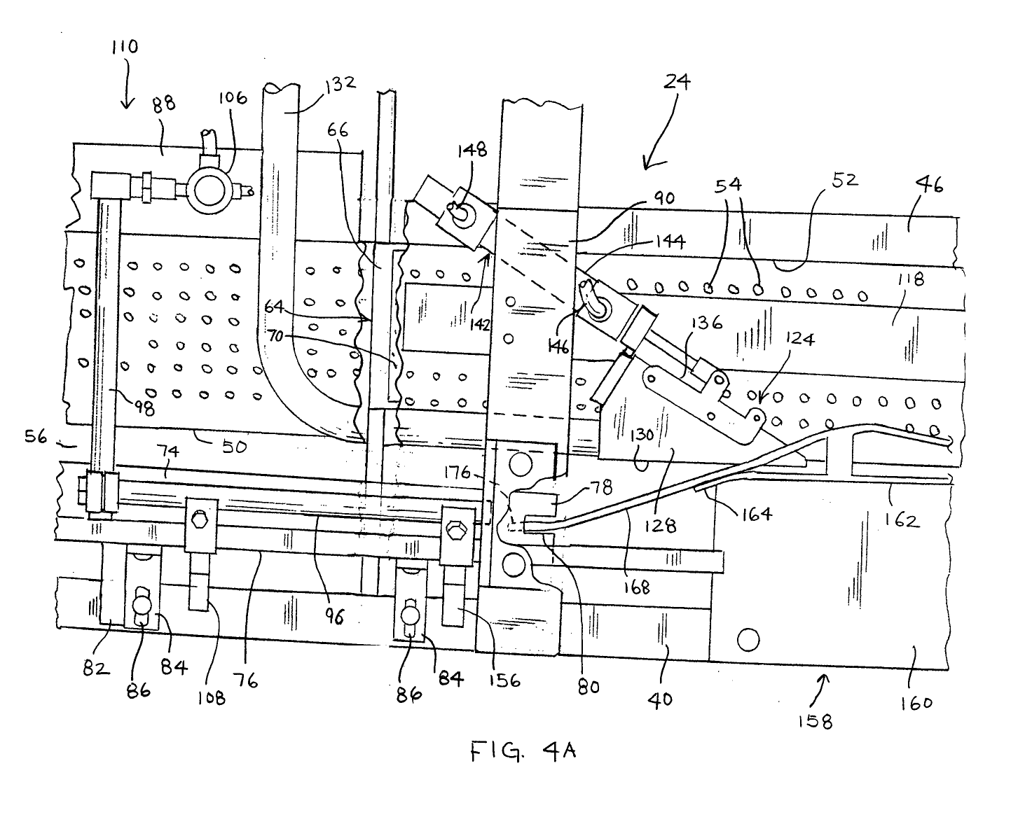

With reference to FIGS. 1-3, the machine 10 includes a frame assembly 20 and a vacuum conveyor assembly 22 which is mounted on the frame assembly 20 for receiving and transporting individual shells from the upstream end 12 of the machine 10 toward the downstream end 14. A filling and folding area 24 (see FIG. 4) is formed over or at an area defined generally by the vacuum conveyor assembly 22 for filling and folding shells transported therethrough by the vacuum conveyor assembly 22. A bias-rolling conveyor assembly 26 is suspended above the vacuum conveyor assembly 22 for engaging filled and partially folded shells and rolling them so as to form rolled food products, such as taquitos, while a take-away conveyor assembly 28 is juxtaposed against the vacuum conveyor assembly 22 for receiving rolled shells from the vacuum conveyor assembly 22 and dispensing them from the downstream end 14 of the machine 10. Each of the foregoing components of the machine 10 will be discussed in greater detail hereinbelow together with other components of the machine 10.

The Frame Assembly

With reference to FIG. 1, the frame assembly 20 includes a pair of vertically oriented beams 30a, 30b, which are positioned at or adjacent the upstream end 12 of the machine 10, and a pair of vertically oriented beams 32a, 32b, which are positioned at or adjacent the downstream end 14 of the machine 10. Horizontal transverse struts 34a, 34b interconnect the beams 30a, 30b to one another, while horizontal transverse struts 36a, 36b interconnect the beams 32a, 32b to one another. The horizontal struts 34a, 36a are positioned above the horizontal struts 34b, 36b, respectively. Similarly, a horizontal strut 38a extends axially along the lateral side 16 of the machine 10 and interconnects the beams 30a, 32a to each other, while a horizontal strut 38b extends axially along the lateral side 18 of the machine 10 and interconnects the beams 30b, 32b to each other.

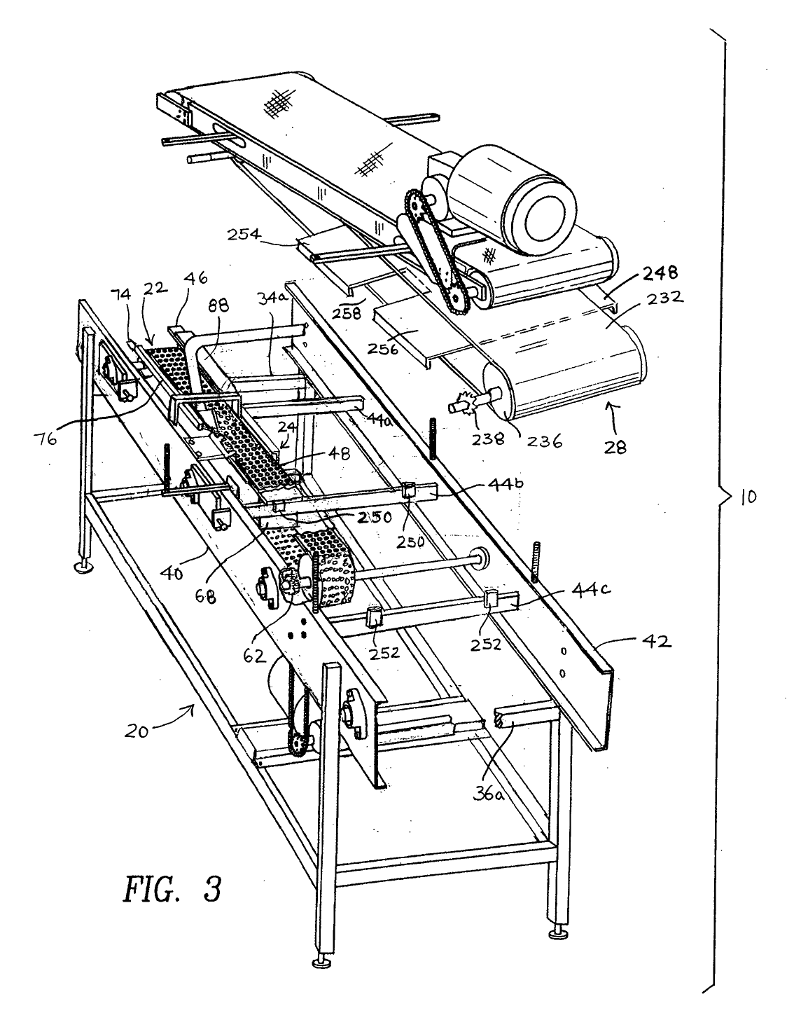

Now referring primarily to FIGS. 1 and 3, side support panels 40, 42 extend axially along the lateral sides 16, 18, respectively, of machine 10 between the upstream and downstream ends 12, 14. The side panel 40 is mounted to the vertical beams 30a, 32a, while the side panel 42 is mounted to the vertical beams 30b, 32b. The side panels 40, 42 are also supported by the horizontal struts 34a, 36a, respectively. The frame assembly 20 further includes horizontal transverse struts 44a-44c (see FIG. 3) extending between the side panels 40, 42. An intermediate panel 46 is positioned between the side panels 40, 42 and extends axially from the upstream end 12 of the machine 10, terminating at the filling and folding area 24 (see FIG. 7). The intermediate panel 46 is secured to the horizontal strut 34a, as well as to the horizontal strut 44a, which extends through the intermediate panel 46.

The Vacuum Conveyor Assembly

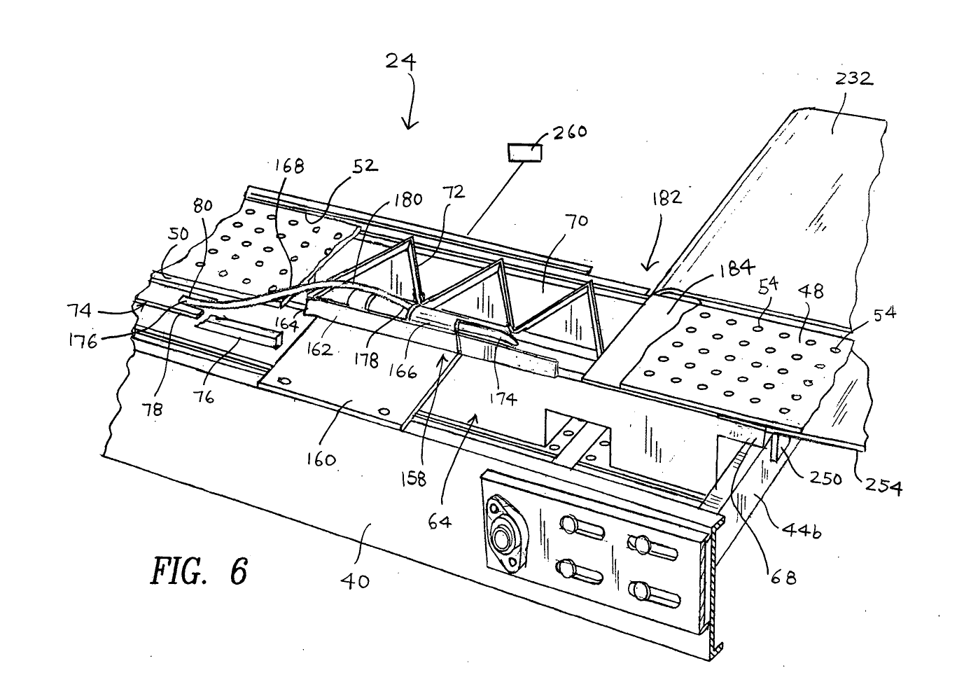

With reference to FIGS. 3, 6 and 7, the vacuum conveyor assembly 22 is positioned along the side panel 40 for transporting individual shells from the upstream end 12 toward the downstream end 14 through the filling and folding area 24 of the machine 10. The vacuum conveyor assembly 22 includes a transport belt 48 having a pair of side edges 50, 52 (see FIGS. 4A and 6) and provided with a plurality of perforations 54 for purposes to be discussed hereinafter. The edge 50 of the transport belt 48 is spaced from the side panel 40 such that a space 56 (see FIG. 4A) is formed therebetween.

Now referring to FIGS. 3, 5 and 7, rotors or rollers 58, 60 are mounted to the frame assembly 20 for rotatably supporting the transport belt 48 thereon. More particularly, the rotor 58 is rotatably supported by the side panel 40 and the intermediate panel 46, while the rotor 60 is rotatably supported by the side panels 40, 42. The rotor 60 is equipped with a gear wheel 62 for causing the rotor 60 and hence the transport belt 48 to rotate.

Referring to FIGS. 3, 4A and 6, the vacuum conveyor assembly 22 includes a vacuum plenum or compartment 64 supported by the frame assembly 20. More particularly, the vacuum plenum 64 is positioned in an area enclosed by the transport belt 48 and has a pair of opposing ends 66, 68. The ends 66, 68 of the vacuum plenum 64 are attached to the transverse struts 44a, 44b for mounting the vacuum plenum 64 to the frame assembly 20. With reference to FIG. 6, the vacuum plenum 64 also has an open upper side 70 which registers with (i.e., is aligned with) an upper portion of the transport belt 48 (i.e., the portion of the transport belt 48 moving above). The open upper side 70 of the vacuum plenum 64 extends along the axial length of the filling and folding area 24 such that suction can be applied to individual shells placed on the transport belt 48 through the perforations 54 so as to inhibit them from moving relative to the transport belt 48 as they pass through the filling and folding area 24. A cross-member 72 having a zigzag shape is placed at the open upper side 70 of the vacuum plenum 64 for supporting the transport belt 48 thereon (i.e., for preventing the transport belt 48 from sagging).

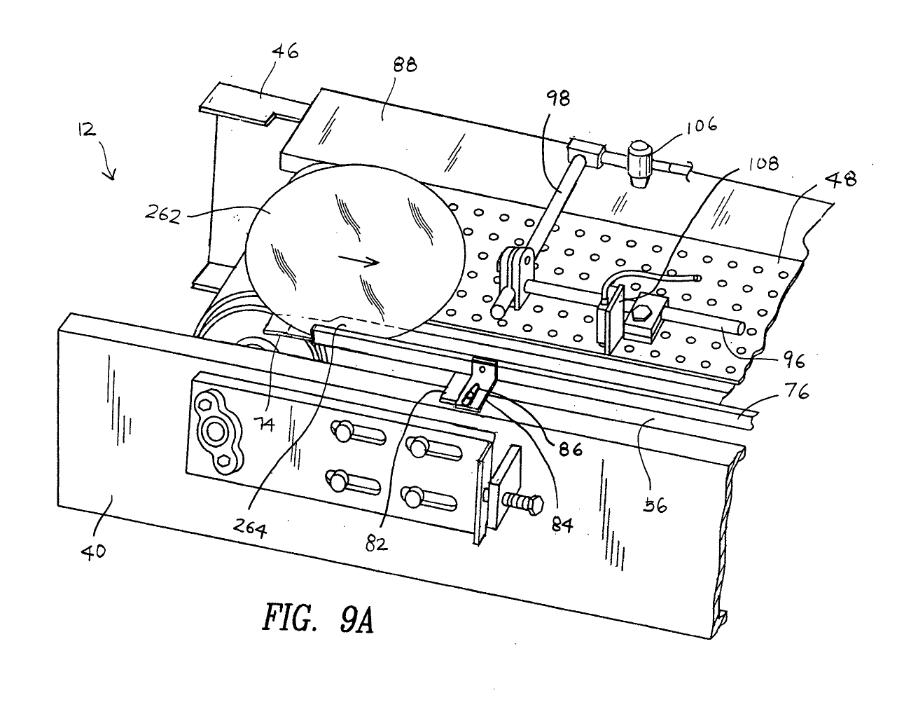

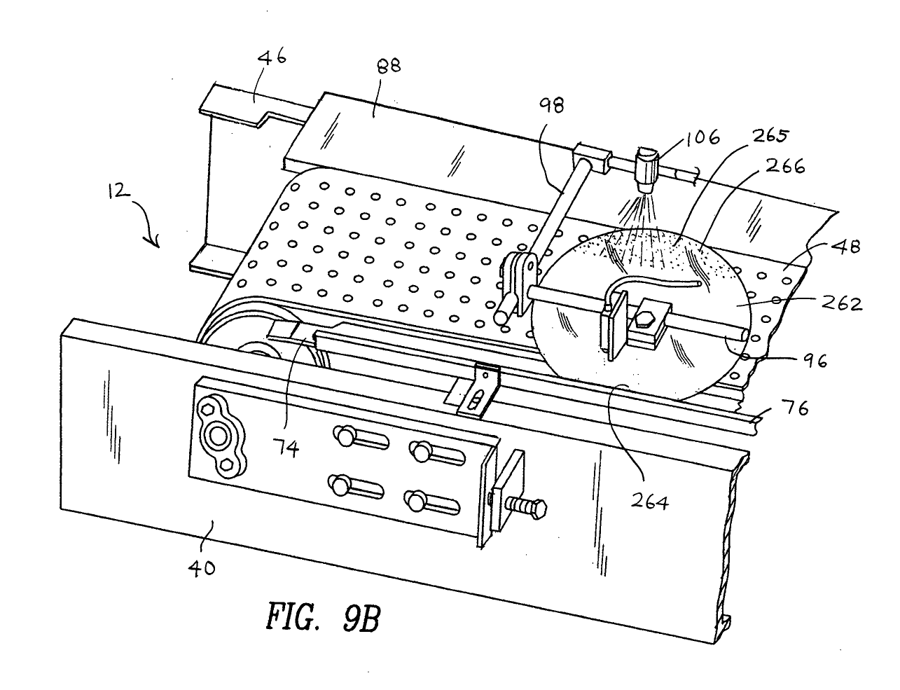

Now referring to FIGS. 4, 4A, 6 and 9A, a support strip 74 and the guide rail 76 are placed in the space 56 between the transport belt 48 and the side panel 40 (see also FIG. 9A). More particularly, the support strip 74 extends axially along the transport belt 48 from the upstream end 12 (see FIG. 9A) toward the downstream end 14 and terminates at the filling and folding area 24 (see FIG. 6) for supporting edges of shells as they are transported by the transport belt 48. The support strip 74 has an end 78 (see FIG. 6) positioned remote from the upstream end 12 of the machine 10 and having a slot 80 formed therein for purposes to be discussed hereinafter.

Still referring to FIGS. 4, 4A, 6 and 9A, the guide rail 76 extends axially from the upstream end 12 of the machine 10 and terminates at a location positioned beyond the end 78 of the support strip 74. The guide rail 76 projects upwardly from the support strip 74 so as to guide edges of shells as they are transported from the upstream end 12 to the filling and folding area 24 by the transport belt 48.

With reference to FIGS. 4A and 9A, mounting brackets 82 attach the support strip 74 to the side panel 40, while mounting brackets 84 attach the guide rail 76 to the side panel 40. Each of the mounting brackets 82, 84 is provided with an elongated slot 86 such that the lateral position of the support strip 74 and the guide rail 76 can be adjusted so as to accommodate shells having different sizes. For instance, when relatively large shells are used, the support strip 74 and the guide rail 76 can be moved toward the side panel 40 and affixed in position so as to provide additional room for such shells.

With reference to FIGS. 3-4A, a support strip 88 is fixedly mounted on the intermediate panel 46 adjacent the upstream end 12 of the machine 10. More particularly, the support strip 88 extends along the side edge 52 of the transport belt 48 from the upstream end 12 and terminates at the filling and folding area 24 for supporting edges of shells transported by the transport belt 48.

The Filling and Folding Area

With reference to FIGS. 4, 4A and 7, the filling and folding area 24 of the machine 10 is provided with a crossbar 90 suspended above and across the transport belt 48 by way of vertical beams 92, 94 mounted on the side panel 40 and the intermediate panel 46, respectively. A support rod 96 (see FIGS. 7 and 9A) extends from the crossbar 90 toward the upstream end 12 of the machine 10 such that it is suspended above the transport belt 48, while a cross-beam 98 (see FIG. 9A) extends across the transport belt 48 from the support rod 96 laterally toward the intermediate panel 46. A bracket 100 also depends from the crossbar 90 for purposes to be discussed hereinafter.

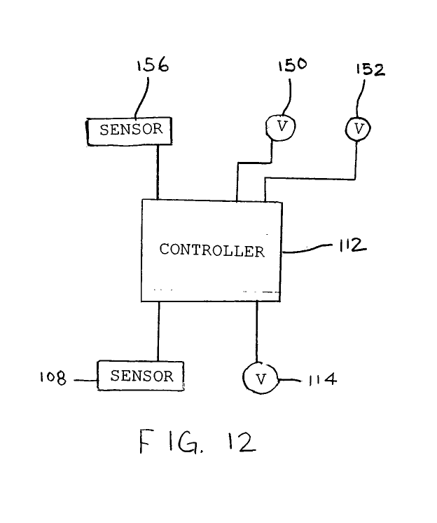

Referring to FIGS. 4A and 9A, a spray 106 and an optical sensor 108 are positioned at an upstream end 110 of the filling and folding area 24. More particularly, the optical sensor 108 is mounted to the support rod 96 and is adapted to sense the presence of a shell passing through the upstream end 110 of the filling and folding area 24 and to send an appropriate electrical signal to a controller 112 (see FIG. 12) in a conventional manner. The spray 106 is mounted to the cross-beam 98 such that it is suspended generally above the side edge 52 of the transport belt 48. The spray 106 is connected to a valve 114 (see FIGS. 7 and 12) which is, in turn, connected to a supply 116 (see FIG. 7) of edible adhesive material (e.g., a water-based mixture of flour and egg white) such that when an electrical signal is transmitted to the controller 112 from the sensor 108, a spray of adhesive material is discharged from the spray 106 onto edges of shells passing therebelow.

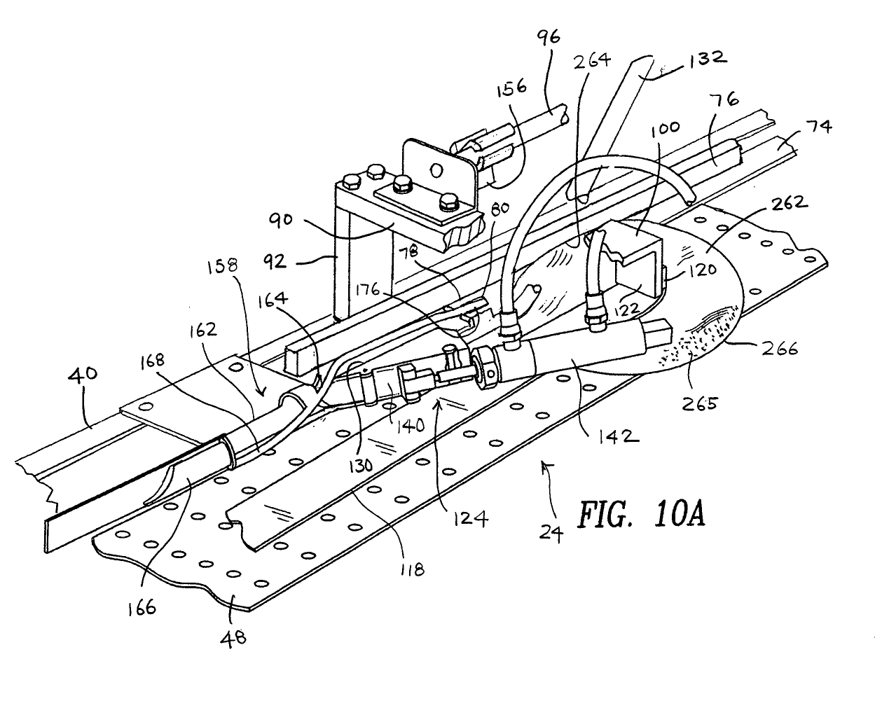

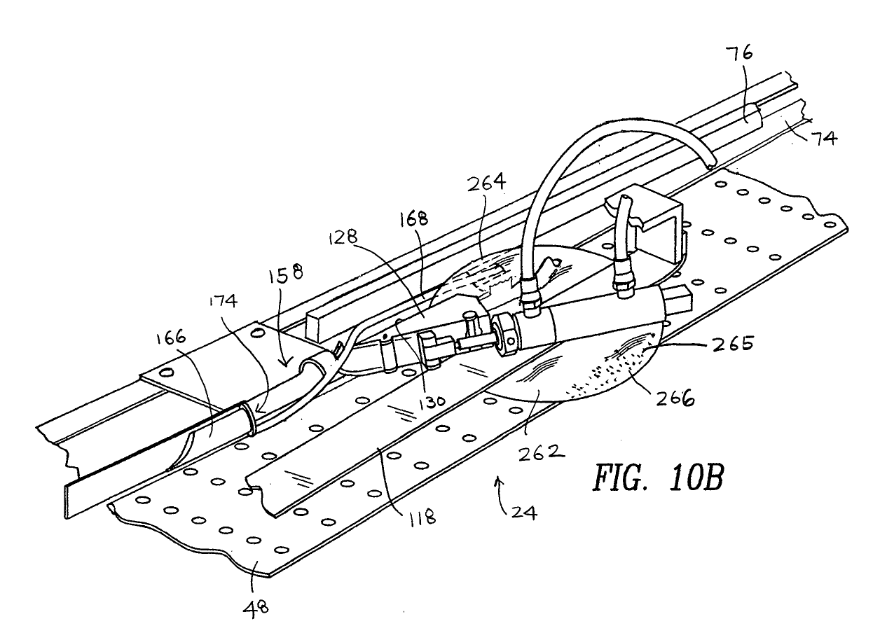

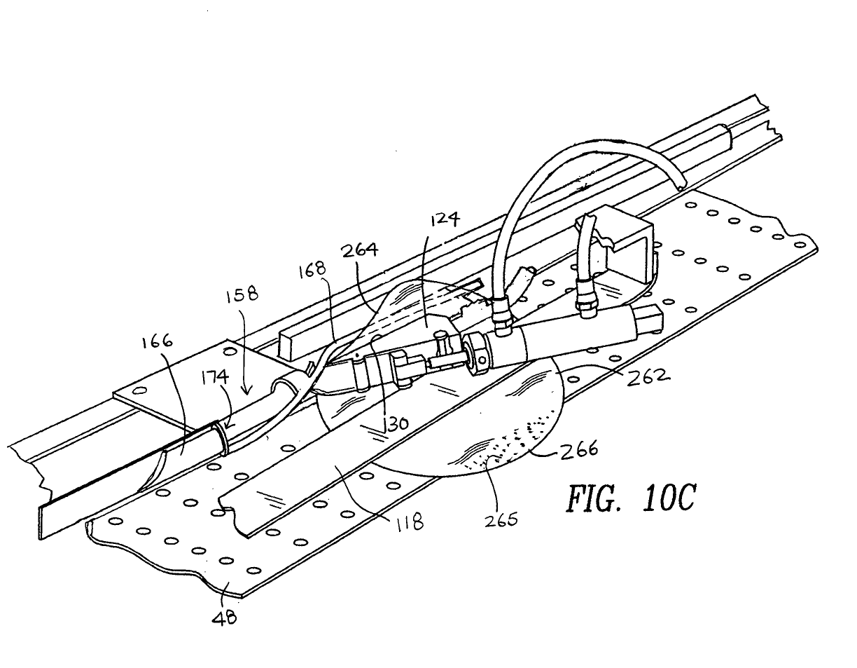

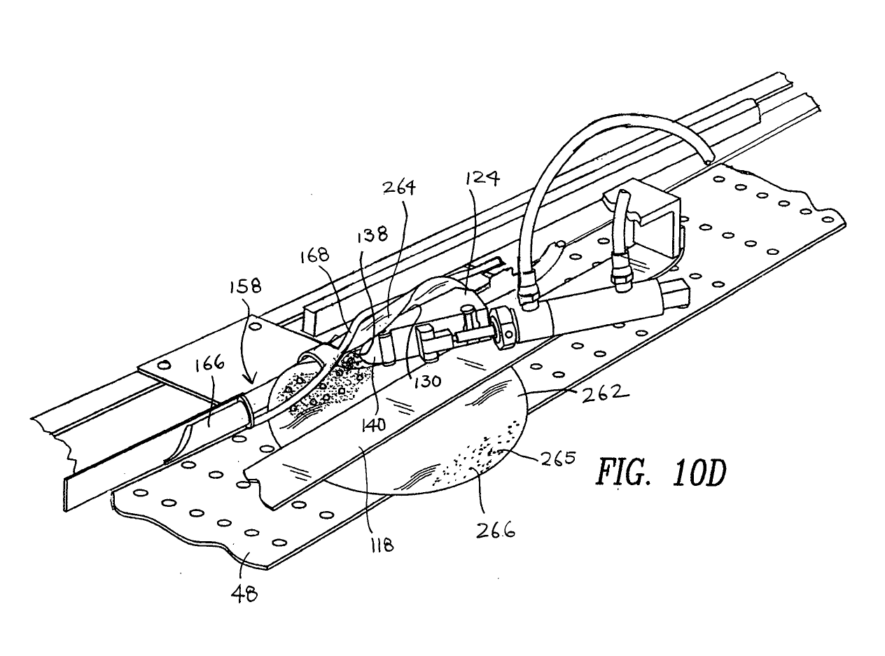

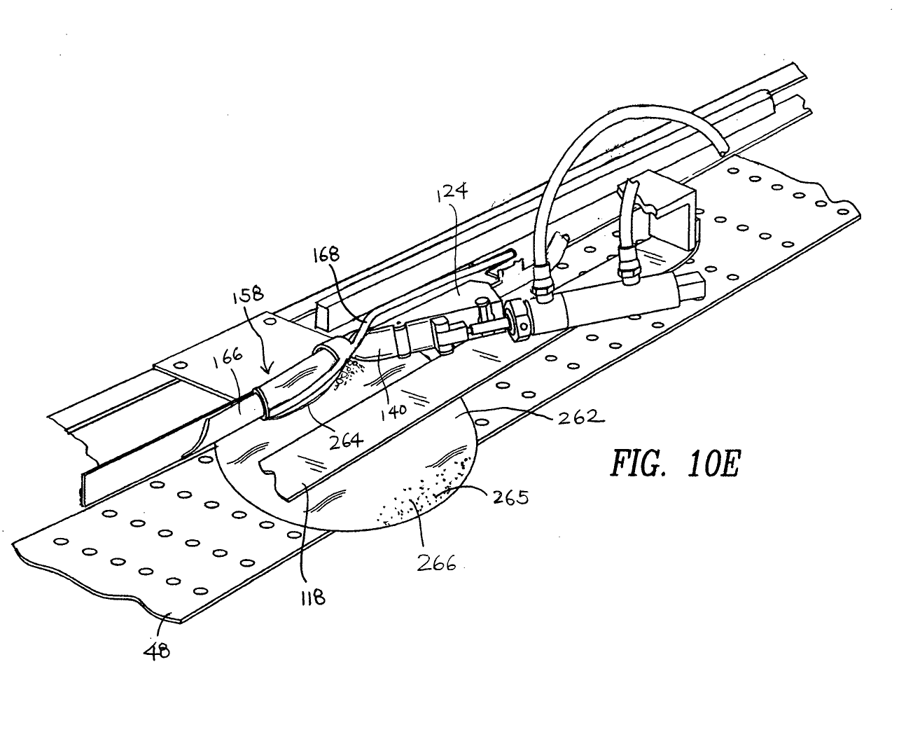

Turning attention to FIGS. 7 and 10A, an elongated hold-down strip 118 is laid on top of the transport belt 48, extending axially through the filling and folding area 24. The hold-down strip 118, which has an upstream end 120, is made from a flexible material and is provided with a sufficient thickness and weight so as to hold down individual shells passing therebelow. The bracket 100 secures the hold-down strip 118 to the crossbar 90. More particularly, the bracket 100 has a lower end 122 terminating above the transport belt 48 such that the upstream end 120 of the hold-down strip 118 is lifted up from the transport belt 48 so as to facilitate the passage of individual shells beneath the hold-down strip 118.

A filling nozzle 124 (see FIGS. 4A and 7) is supported from the crossbar 90 for releasing an appropriate amount of filling materials (e.g., a mixture of sauce, vegetables, etc.) onto individual shells transported through the filling and folding area 24 by the transport conveyor 48. More particularly, a bracket 126 connects the nozzle 124 to the crossbar 90 such that the nozzle 124 is positioned slightly above the transport belt 48 so as to permit passage of individual shells therebelow. The nozzle 124 has a generally triangular body 128 (referred to hereinafter as “the nozzle body”) having a lateral side 130 which substantially overlies the side edge 50 of the transport belt 48 and which has a curved profile for purposes to be discussed hereinafter.

Now referring to FIGS. 4 and 7, a supply tube 132 is connected to the nozzle body 128 for conveying filling materials to the nozzle 124 from a conventional filling material supply unit 134 (see FIG. 4), such as those sold by VEMAG Maschinenbau GmbH, Germany, under model “ROBBY”. The nozzle body 128 also has a slanted side 136 equipped with an outlet 138 (see FIG. 10D) for dispensing filling materials therefrom. A cover plate 140 is movably mounted to the side 136 of the nozzle body 128 for selectively opening and closing the outlet 138 of the nozzle 124, while a pneumatically operated actuator 142 is fixedly attached to the nozzle body 128 and is connected to the cover plate 140 for moving the cover plate 140 between its open and closed positions. More particularly, the actuator 142 includes a cylinder 144 and a pair of supply tubes 146, 148. The tubes 146, 148 connect the cylinder 144 to valves 150, 152, respectively, for selectively supplying pressurized air from a pressurized air source 154 to the cylinder 144 so as to operate a piston (not shown) mounted therein in a conventional manner.

An optical sensor 156 (see FIGS. 10A and 12) is supported from the support rod 96 immediately upstream from the nozzle 124. More particularly, the optical sensor 156 is mounted to the support rod 96 via a mounting bracket such that its axial position can be adjusted (i.e., it can be moved axially toward or away from the nozzle 124). The optical sensor 156 is adapted to sense the presence of a shell passing thereby and to send an appropriate electrical signal to the controller 112 in a conventional manner for actuating an appropriate one of the valves 150, 152 for causing the nozzle 124 to be in its dispensing mode for a predetermined time period.

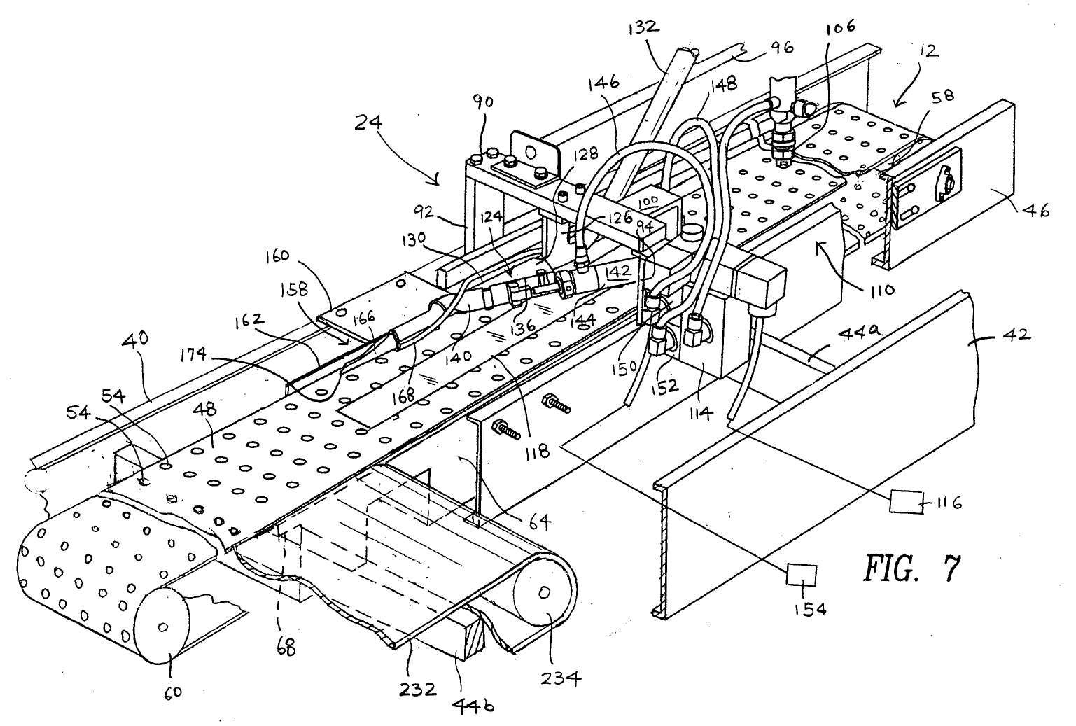

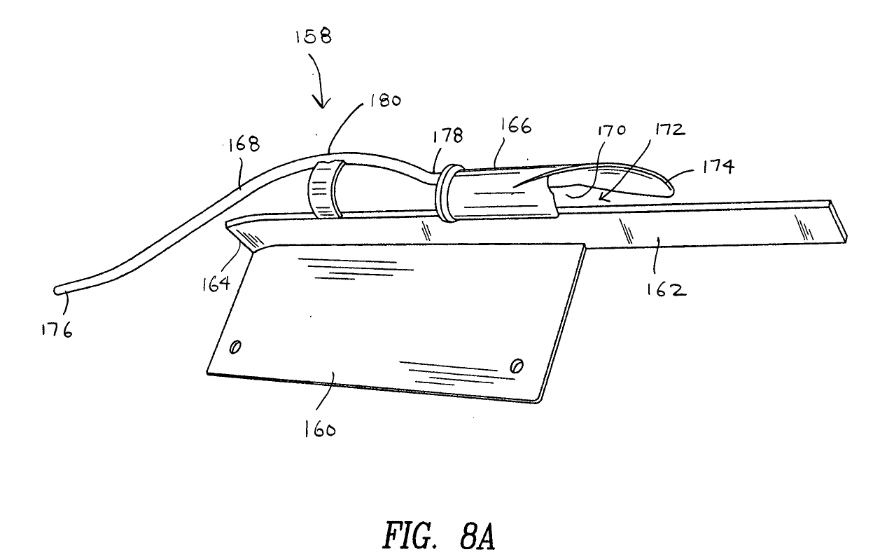

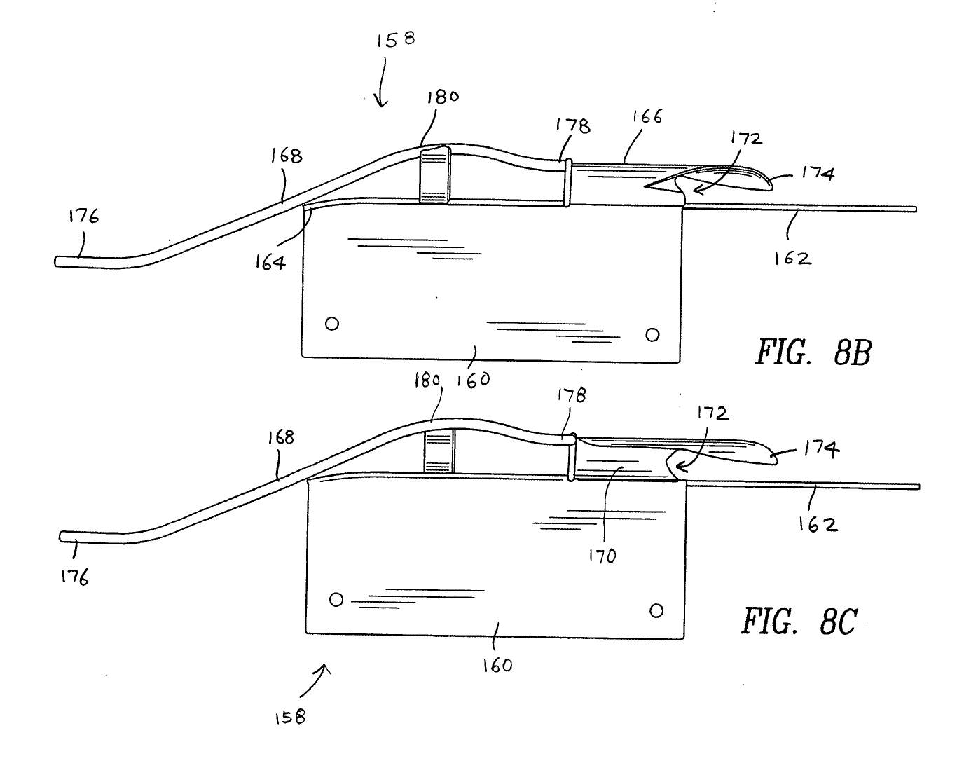

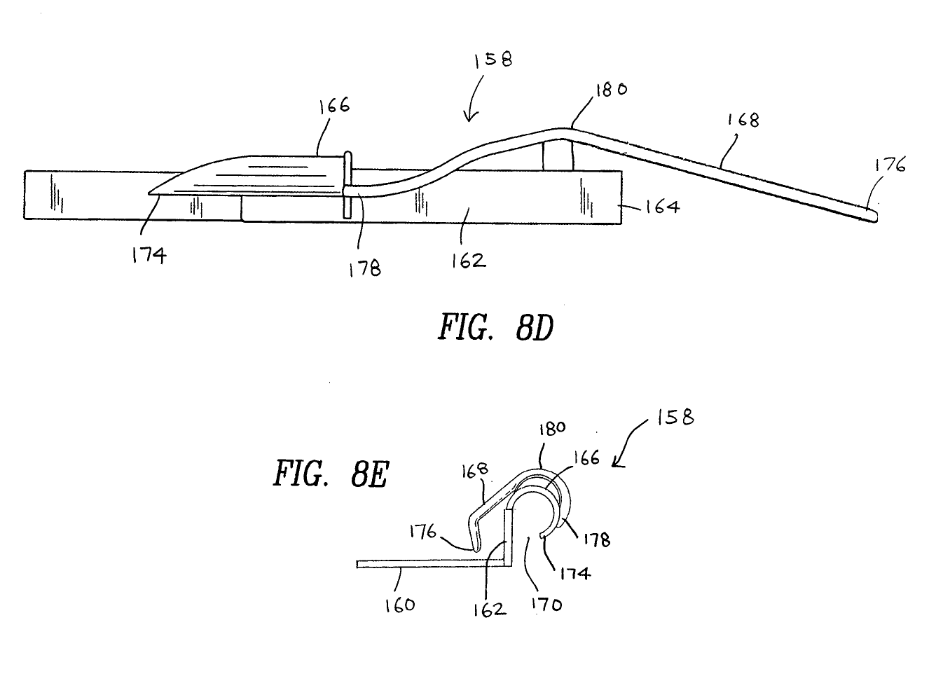

With reference to FIGS. 6-8E and 10A, a plow 158 is mounted to the side panel 40 at the filling and folding area 24. More particularly, the plow 158, which extends generally axially, includes a horizontal support plate 160 for mounting the plow 158 from the side panel 40. A rail 162 projects substantially vertically from the support plate 160 and extends axially along the side edge 50 of the transport belt 48. The rail 162 is positioned such that it is offset axially relative to the lateral side 130 of the nozzle body 128 (see FIG. 4A) so as to allow individual shells to pass between the rail 162 and the lateral side 130 of the nozzle body 128 during a folding operation. The rail 162 has a proximal end 164 which is slanted toward the side panel 40 to facilitating passage of individual shells between the nozzle body 128 and the rail 162.

The plow 158 is also equipped with a plow cover 166 and a rigid plow wire 168. The plow cover 166 has an actuate profile and extends laterally from the rail 162 such that it overlies the side edge 50 of the transport belt 48. Moreover, the plow cover 166 includes an open bottom side 170 so as to form a tunnel 172 therebelow. The plow cover 166 also includes a tip 174 spiraling generally inwardly as it extends axially from the plow cover 166 toward the downstream end 14 of the machine 10.

The plow wire 168 has an upstream end 176 and a downstream end 178. The downstream end 178 of the plow wire 168 is attached to a bottom portion of the plow cover 166 opposite the rail 162, while the upstream end 176 of the plow wire 168 is inserted into the slot 80 of the support strip 74 (see FIGS. 4A and 6) such that it is positioned below the support strip 74. As the plow wire 168 extends generally axially from the upstream end 176 to the downstream end 178 thereof, it rises upwardly and bends laterally inwardly toward the side 18 of the machine 10 until it reaches a peak 180. Once reaching the peak 180, the guide wire 168 descends downwardly and bends generally toward the side 16 of the machine 10. The foregoing configuration of the plow wire 168 and the plow cover 166 facilitates initial folding of an edge or side of a shell as will be discussed in greater detail hereinbelow.

The plow 158 defines a downstream end 182 (see FIG. 6) of the filling and folding area 24. As discussed above, the open upper side 70 of the vacuum plenum 64 extends between the upstream and downstream ends 110, 182 of the filling and folding area 24. More particularly, the open upper side 70 of the vacuum plenum 64 extends from a location adjacent the upstream end 120 of the hold-down strip 118 (see FIG. 4A). A cover plate 184 (see FIG. 6) is placed adjacent the end 68 of the vacuum plenum 64 so as to block off the open upper side 70, thereby preventing application of suction to the transport belt 48 beyond the downstream end 182 of the filling and folding area 24.

The Bias-Rolling Conveyor Assembly

Referring primarily to FIGS. 1, 2 and 4, the bias-rolling conveyor assembly 26 spans above the vacuum conveyor assembly 22 and the take-away conveyor assembly 28. The bias-rolling conveyor assembly 26 includes a bias-rolling belt 186 positioned in a slated or angled orientation relative to the transport belt 48 such that it extends from the side 16 of the machine 10 adjacent the filling and folding area 24 toward the side 18 of the machine 10 adjacent the downstream end 14 of the machine 10. More particularly, the bias-rolling belt 186 substantially covers the portion of the transport belt 48 located downstream from the filling and folding area 24 for rolling shells received therefrom. As a result of its angular orientation, the bias-rolling belt 186 moves in a direction which is at an angle relative to the direction of movement of the transport belt 48 and therefore has a forward velocity component (as indicated by arrow A in FIG. 4), as well as a lateral or transverse velocity component (as indicated by arrow B in FIG. 4). The bias-rolling belt 186 is positioned above the transport belt 48 such that a shell transported by the transport belt 48 can be engaged by the bias-rolling belt 186. Due to its lateral velocity component, the bias-rolling belt 186 is adapted to cause a shell engaged thereby to roll as will be discussed in greater detail hereinbelow.

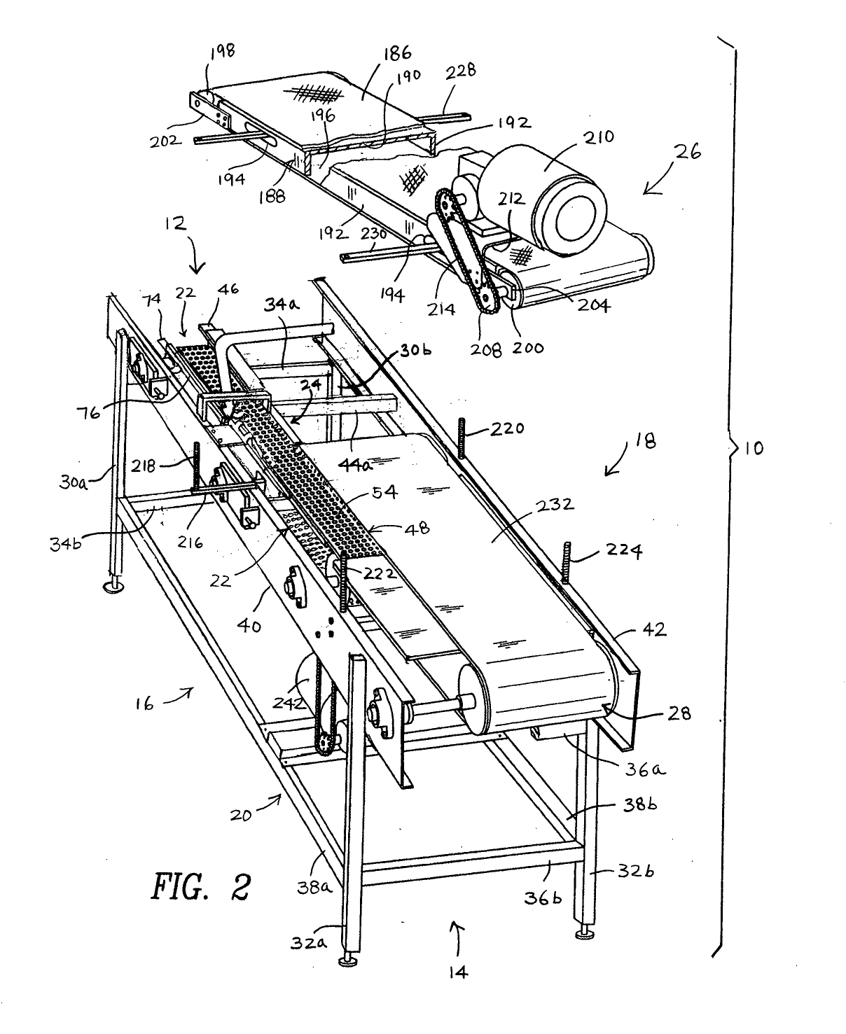

With primary reference to FIG. 2, the bias-rolling conveyor assembly 26 also includes an inverted U-shaped channel 188 positioned in the bias-rolling belt 186 and having a substantially horizontal panel 190 and a pair of side panels 192 depending from the horizontal panel 190. Each of the side panels 192 includes a pair of elongated slots 194. The channel 188 further includes an open bottom end 196 which is aligned with the bias-rolling belt 186 so as to provide a play to a lower portion of the bias-rolling belt 186 (i.e., a portion of the bias-rolling belt 186 moving below).

Rotors or rollers 198, 200 (see FIG. 2) frictionally engage the bias-rolling belt 186. The rotor 198 is rotatably supported from an upstream end of the channel 188 by way of support bars 202 (only one of which is shown in FIG. 2), while the roller 200 is rotatably supported from a downstream end of the channel 188 by way of support bars 204 (only one of which is shown in FIG. 2). The roller 200 includes a gear wheel 208 for purposes to be discussed hereinafter.

The bias-rolling conveyor assembly 26 is provided with a motor 210. An L-shaped bracket 212 is attached to one of the side panels 192 of the channel 188 for supporting the motor 210 above the bias-rolling belt 186. A loop chain 214 is provided for connecting the gear wheel 208 to the motor 210 so as to rotate the bias-rolling belt 186 at a pre-selected speed.

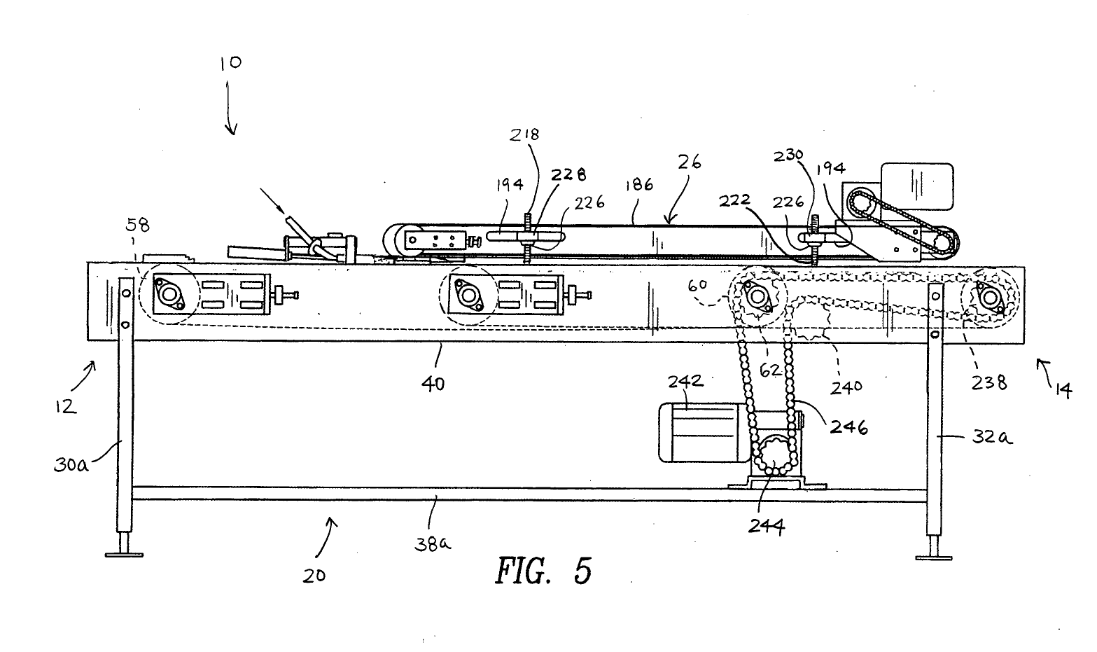

Referring back to FIGS. 1 and 2, supporting beam assemblies are mounted on the frame assembly 20 for suspending the bias-rolling belt 186 above the transport belt 48 and the take-away conveyor assembly 28. More particularly, a lower beam 216 extends laterally outwardly from the side panel 40 of the frame assembly 20, while threaded rods 218, 220 project upwardly from the lower beam 216 and the side panel 42, respectively. Similarly, threaded rods 222, 224 project upwardly from the side panels 40, 42, respectively. A support nut 226 (see FIG. 5) is threaded onto each of the threaded rods. A support beam 228 extends transversely between the threaded rods 218, 220, while a support beam 230 extends transversely between the threaded rods 222, 224. More particularly, the support beam 228 includes mounting holes at opposing ends thereof such that it can be mounted onto the threaded rods 218, 220 and be supported thereon by the nuts 226 (see FIG. 5). Likewise, the support beam 230 includes mounting holes at opposing ends thereof such that it can be mounted onto the threaded rods 222, 224 and be supported thereon by the nuts 226 (see FIG. 5). The support beams 228, 230 also extend across the channel 188 of the bias-rolling conveyor assembly 26 through the slots 194 and thereby cooperate with each other to support the channel 188 and hence the bias-rolling conveyor assembly 26 on the threaded rods 218-224. The vertical position of the support beams 228, 230 and hence the bias-rolling belt 186 relative to the transport belt 48 can be adjusted easily by raising or lowering the nuts 226 threaded on the threaded rods 218-224. Because the bias-rolling conveyor assembly 26 is movably supported on the support beams 228, 230, the angular orientation of the bias-rolling belt 186 relative to the transport belt 48 can be adjusted by pivoting either the upstream end or the downstream end of the bias-rolling conveyor assembly 26.

The Take-Away Conveyor Assembly

Referring primarily to FIG. 2, the take-away conveyor assembly 28 is positioned along the side 18 of the machine 10 for receiving from the transport belt 48 individual shells rolled by the bias-rolling belt 186. More particularly, the take-away conveyor assembly 28 includes a take-away belt 232 extending axially from a location adjacent the downstream end 182 of the filling and folding area 24 and terminating at the discharge end 14 of the machine 10.

Rotors or rollers 234, 236 (see FIGS. 3 and 7) are rotatably mounted to the frame assembly 20 for rotatably supporting the take-away belt 232. More particularly, each of the rotors 234, 236 is rotatably supported by the side panels 40, 42. The rotor 236 has a gear wheel 238 (see FIG. 3) for causing the rotor 236 and hence the take-away belt 232 to rotate.

A support gear wheel 240 (see FIG. 5) is rotatably mounted to the side panel 40, while a motor 242 is mounted on the frame assembly 20 and has a drive gear 244. A loop chain 246 couples the drive gear 244 of the motor 242 to the support gear wheel 240 and the gear wheels 62, 238 of the vacuum conveyor assembly 22 and the take-away conveyor assembly 28, respectively. In this manner, the transport belt 48 and the take-away belt 232 are linked to one another so as to be rotated conjointly by the motor 242 at a predetermined speed.

Referring primarily to FIG. 3, a support panel 248 is positioned below an upper portion of the take-away belt 232 (i.e., a portion of the take-away belt 232 moving above) so as to provide a support for same. The support panel 248 is supported by cleats 250 of the transverse strut 44b and cleats 252 of the transverse strut 44c. The support panel 248 also includes a pair of overhanging portions 254, 256 which are separated from one another by a slot 258. More particularly, the overhanging portion 254 is positioned beneath the upper portion of the transport belt 48 and cooperates with the cover plate 184 of the vacuum plenum 64 so as to provide vertical support for the upper section of the transport belt 48 (see FIGS. 4 and 6). The cover plate 184 and the overhanging portion 254 are positioned downstream from the filling and folding area 24 of the machine 10 and hence provide a rigid surface upon which shells can be rolled by the bias-rolling belt 186.

The Operation of the Machine

With the transport, take-away and bias-rolling belts 48, 186, 232 continuously rotating at their respective speeds and suction being constantly applied to the vacuum plenum 64 from a suction source 260 (see FIG. 6), shells are individually placed onto the transport belt 48 at the upstream end 12 of the machine 10. More particularly, each individual shell 262 is placed onto the transport belt 48 such that an edge 264 of the shell 262 is supported on the support strip 74 and is in alignment or abutment with the guide rail 76 (see FIG. 9A). Once placed on the transport belt 48, the shell 262 is transported by the transport belt 48 to the filling and folding area 24 of the machine 10. During the downstream movement of the shell 262 toward the filling and folding area 24, the edge 264 of the shell 262 is slidably supported by the support strip 74. Because the shell 262 is freely supported on the transport belt 48 (i.e., suction is not yet applied to the shell 262), it can be guided into proper position by the guide rail 76 for processing by the filling and folding area 24.

As the shell 262 moves downstream from the upstream end 12 of the machine 10, it passes beneath the optical sensor 108 (see FIG. 9B). In response, the optical sensor 108 detects the presence of the shell 262 and sends an electrically signal to the controller 112. The controller 112 then causes the valve 114 to move from its closed position to its open position for a predetermined time period, thereby causing the spray 106 to apply a spray of edible adhesive material 265 onto an opposite edge 266 of the moving shell 262 (i.e., an edge of the shell 262 positioned opposite the guide rail 76).

As the shell 262 continues to move downstream from the spraying location, it passes above the open upper side 70 (see FIG. 6) of the vacuum plenum 64. As a result, suction is applied to the shell 262 from the vacuum plenum 64 through the perforations 54 of the transport belt 48 so as to secure the shell 262 to the transport belt 48. Suction is continuously applied to the shell 262 until the shell 262 passes beyond the filling and folding area 24. The shell 262 is also fed underneath the hold-down strip 118 (see FIG. 10A) which further secures the shell 262 to the transport belt 48.

With the shell 262 secured to the transport belt 48, it undergoes a folding operation as it continues to pass through the filling and folding area 24. More particularly, the edge 264 of the shell 262 comes in engagement with the plow wire 168 (see FIG. 10B) and begins to ride same. As a result, the edge 264 of the shell 262 is caused to curl upwardly and wraps around the lateral side 130 of the nozzle body 128 (see FIGS. 10C and 10D), which functions as a mandrel. The partially curled or rolled edge 264 of the shell 262 is then fed into the tunnel 172 of the plow 158 beneath the plow cover 166 (see FIG. 10E).

While the shell 262 is undergoing the folding operation, the controller 112 (see FIG. 12) actuates an appropriate one of the valves 150, 152 so as to cause the cover plate 140 of the nozzle 124 to move to its open position from its closed position for a predetermined time period. As a result, as the shell 262 passes beneath the nozzle 124, filling materials are dispensed therefrom onto the curled or folded edge 264 of the shell 262 (see FIG. 10D).

The foregoing filling operation is initiated by an electrical signal transmitted from the optical sensor 156 (see FIGS. 10A and 12) to the controller 112. Since the optical sensor 156 is positioned upstream from the nozzle 124, when the electrical signal is received by the controller 112, the shell 262 may be at a location upstream from the nozzle 124 and may hence not be in position to receive filling materials. As a result, the controller 112 may be programmed with a time delay. In this manner, the filling operation is initiated after the lapse of a predetermined time period from the time the controller 112 receives the electrical signal to ensure that the shell 262 is in position to receive filling materials from the nozzle 124. Alternatively, the transport belt 48 can be rotated at a relatively high speed such that the shell 262 can be in position to receive filling materials from the nozzle 124 immediately after activating the optical sensor 156 so as to eliminate the need to program the controller 112 with a time delay.

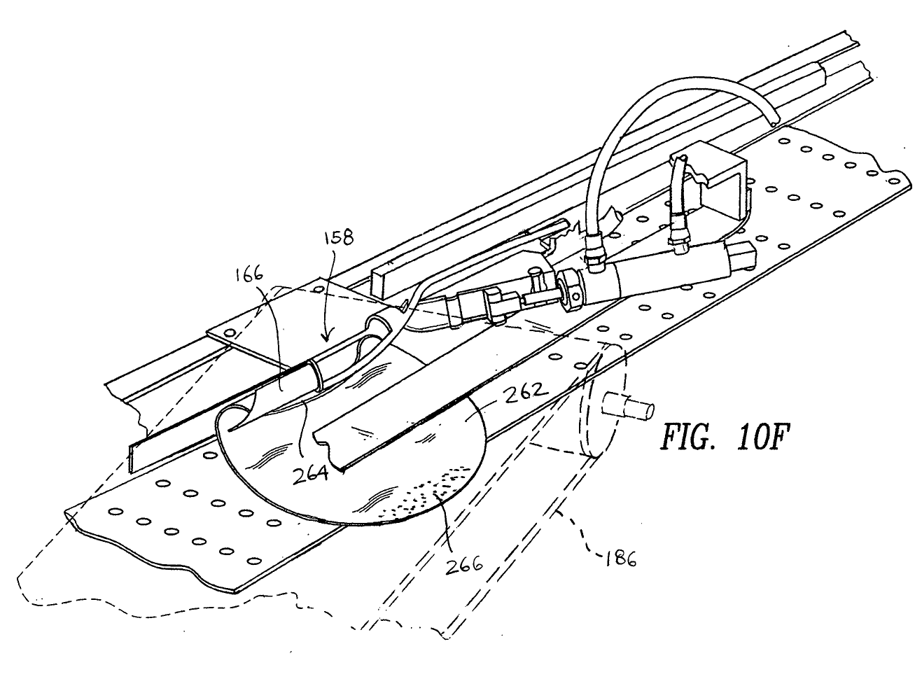

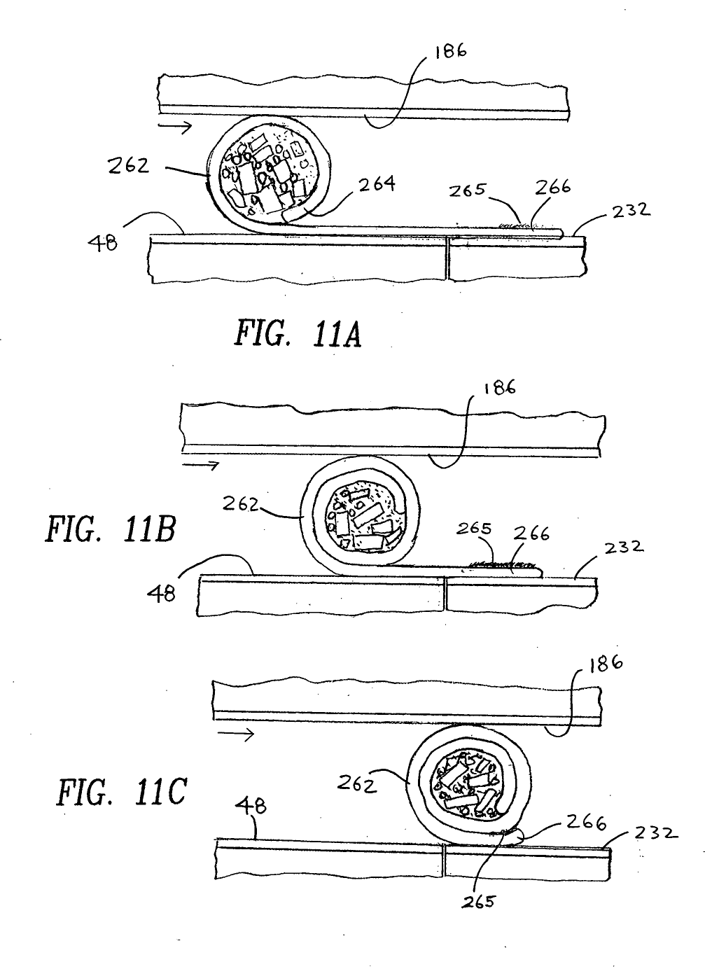

As the curled edge 264 of the shell 262 is fed into and through the tunnel 172 beneath the plow cover 166, it is formed into a roll which wraps around the filling materials dispensed from the nozzle 124 (see FIGS. 10E and 10F). As the shell 262 moves further downstream, its rolled edge 264 leaves the tunnel 172, and the shell 262 is positioned underneath the bias-rolling belt 186 (see FIG. 11A). At this point, the portion of the transport belt 48 supporting the shell 262 is positioned over the cover plate 184 of the vacuum plenum 64 such that suction applied to the shell 262 is terminated, thereby permitting the movement of the shell 262 relative to the transport belt 48. Moreover, the opposite edge 266 of the shell 262 is placed on the take-away belt 232 (see FIG. 11A). Because the take-away belt 232 and the transport belt 48 rotate at the same speed, they cooperate with one another to transport the shell 262 positioned below the bias-rolling belt 186 toward the downstream end 14 of the machine 10.

When placed underneath the bias-rolling belt 186, the shell 262 is engaged by same and is caused to roll in a lateral or transverse direction (see FIGS. 10F and 11A). More particularly, since the bias-rolling belt 186 has a lateral velocity component (see arrow B in FIG. 4), as the shell 262 is transported downstream by the transport belt 48 and the take-away belt 232, the bias-rolling belt 186 causes the shell 262 to roll upon itself (see FIGS. 11B and 11C and broken line schematic representations b and c of the shell 262 in FIG. 4).

It is noted that the areas of the transport belt 48 and the take-away belt 232 upon which the foregoing rolling operation is performed are supported by the cover plate 184 of the vacuum plenum 64 and/or the support panel 248 of the take-away conveyor assembly 28. In this manner, the transport belt 48 and the take-away belt 232 are inhibited from sagging, thereby ensuring that the shell 262 is constantly engaged by the bias-rolling belt 186 for the performance of the rolling operation. On the other hand, the bottom portion of the bias-rolling belt 186 which engages the shell 262 (i.e., the portion of the bias-rolling belt 186 traveling below) is aligned with the open bottom end 196 of the inverted U-shaped channel 188. As a result, the bias-rolling belt 186 is adapted to move upwardly to compensate for the increasing thickness of the shell 262 as it is rolled to its final form.

Due to its angular orientation, the bias-rolling belt 186 also has a forward velocity component (see arrow A in FIG. 4). The speed and the angle of the bias-rolling belt 186 are set such that its forward component matches with the line speed of the transport belt 48 and the take-away belt 232 so as not to cause damage to the shell 262 placed between the bias-rolling belt 186 and the transport and take-away belts 48, 232. As discussed above, the angular orientation of the bias-rolling belt 186 can be adjusted by pivoting the upstream or downstream end thereof. By adjusting the angular orientation of the bias-rolling belt 186, the extent of its lateral and forward velocity components can be adjusted to achieve desirable conditions.

As the shell 262 moves further downstream while being engaged by the bias-rolling belt 186, it is rolled completely upon itself (see FIG. 11C). At this point, because the edge 266 is positioned on the take-away belt 232, the entire rolled shell 262 is placed on the take-away belt 232. That is, as the shell 262 becomes rolled, it is automatically transferred onto the take-away belt 232 (see broken line representation c of the shell 262 in FIG. 4). Thereafter, the rolled shell 262 is transported by the take-away belt 232 to the downstream end 14 of the machine 10 while still being rolled by the bias-rolling belt 186 so as to be dispensed therefrom (see broken line representations d, e and f of the shell 262 in FIG. 4). A conventional transport/handling mechanism (not shown), such as a conveyor belt, can be placed in an abutting fashion relative to the downstream end 14 so as to receive the rolled shell 262 and to transport same to another location for further handling/processing. The adhesive material 265 applied to the shell 262 maintains the shell 262 glued together in its rolled form.

It should be appreciated that the present invention provides numerous benefits and advantages over the prior art discussed above. For instance, the present invention is adapted to fill and roll shells or sheets of covering material to form rolled food product, such as taquitos. Moreover, the present invention is adapted for easy adjustment to accommodate manufacturing of different types of rolled food products.

It should be noted that the present invention can have numerous modifications and variations. For instance, shells can be conveyed manually or automatically onto the transport belt 48 at the upstream end 12 of the machine 10. By way of example, shells can be fed to the machine 10 automatically from a shell making machine positioned upstream from the machine 10. If shells are made remotely, they can be placed directly onto the transport belt 48, for instance, from a stacked source, with the use of a dispensing mechanism or by hand. The vacuum conveyor assembly 22 and the take-away conveyor assembly 28 can also be made as a single assembly. In such circumstances, the transport belt 48 and the take-away belt 232 can be formed as a single belt performing all of their functions.

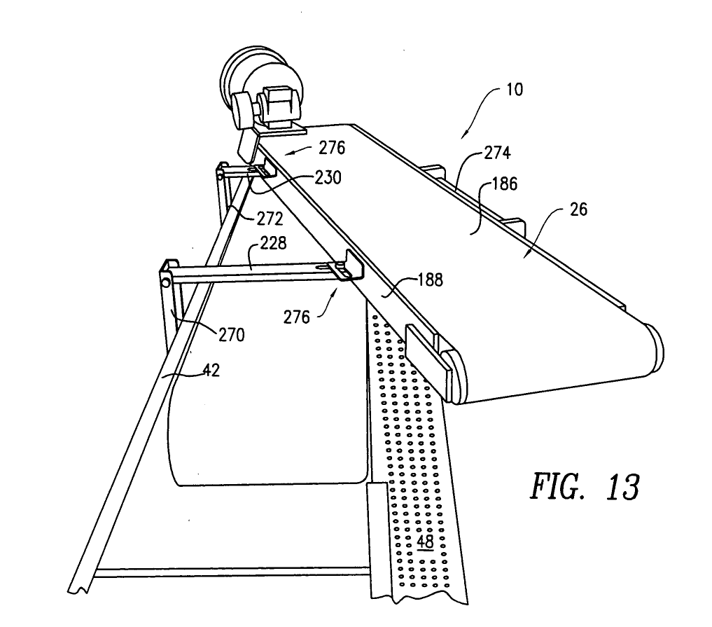

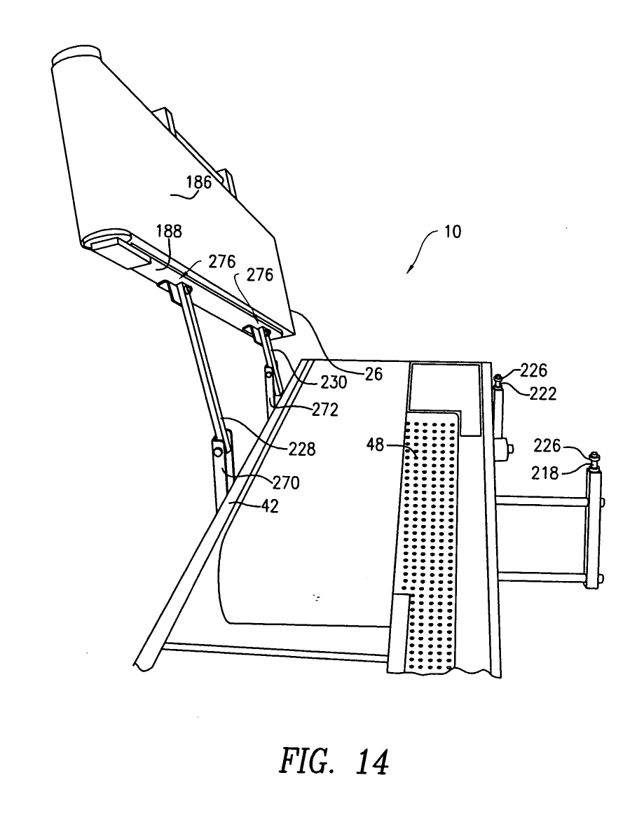

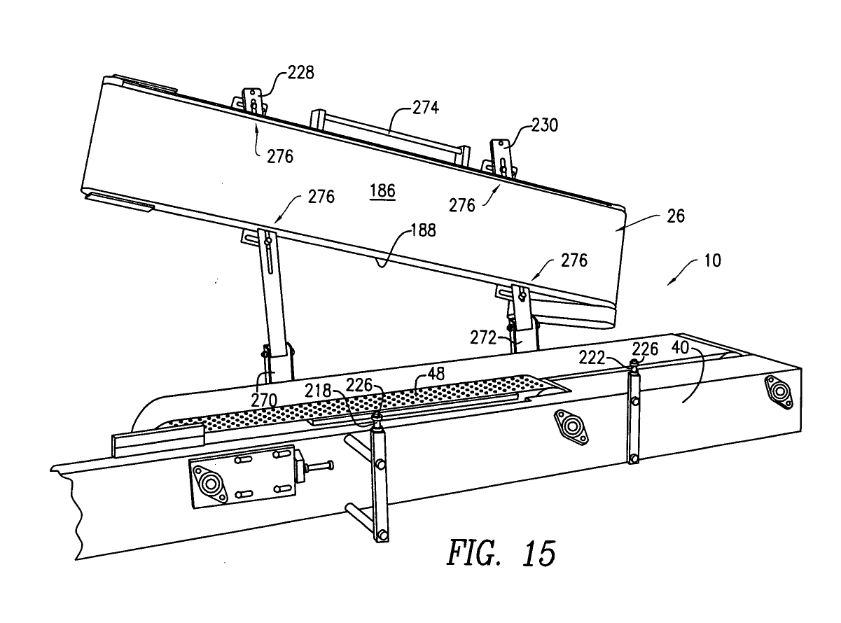

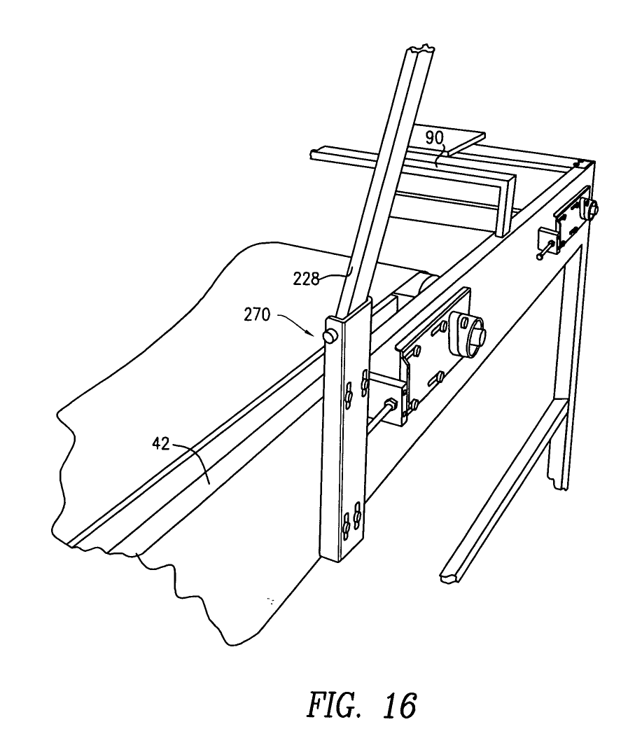

FIGS. 13-16 illustrate further medications which can be included in the present invention. For instance, the support beams 228, 230 of the U-shaped channel 188 of the bias-rolling conveyor assembly 26 can be pivotally attached to support members 270, 272, respectively, which are affixed to the side panel 42 such that the bias-rolling conveyor assembly 26 can be lifted or pivoted upwardly from its “closed” or “down” position (see FIG. 13) to its “open” or “up” position (see FIGS. 14 and 15). By positioning the bias-rolling conveyor assembly 26 in its “open” position, various parts of the machine 10 (e.g., the bias-rolling belt 186 and the transport belt 48) become exposed for easy cleaning and/or replacement. The U-shaped channel 188 can be provided with a handle 274 for facilitating the lifting of the bias-rolling conveyor assembly 26. In the “closed” position of the bias-rolling conveyor assembly 26, the free ends of the support beams 228, 230 opposite the support members 270, 272, respectively, are removably supported on upper ends of the threaded rods 218, 222, respectively, by way of the support nuts 226. In order to implement the modifications discussed herein, the U-shaped channel 188 needs to be immovably affixed to the support beams 228, 230, for instance, by way of removably attaching mechanisms 276 (e.g., nuts and bolts) so as to prevent the bias-rolling conveyor assembly 26 from moving relative to the support beams 228, 230. The support members 270, 272 can be attached to the side panel 42 such that their vertical positions can be adjusted, thereby allowing the bias-rolling conveyor assembly 26 to be raised or lowered to accommodate changing operational requirements. With reference to FIG. 16, the crossbar 90 can be modified such that it can span the lateral width of the machine 10 and be supported by the support panels 40, 42.

It will be understood that the embodiment described herein is merely exemplary and that a person skilled in the art may make many variations and modifications without departing from the spirit and scope of the invention. All such variations and modifications, including those discussed hereinabove, are intended to be included within the scope of the invention as defined by the appended claims.

We claim:

1. Apparatus for making rolled food products, comprising dispensing means for dispensing edible filling materials onto a generally planar shell; and rolling means for making the shell dispensed with the filling materials into a roll.

2. The apparatus of claim 1, further comprising a supporting structure having upstream and downstream ends, said rolling means including moving means for moving a shell placed thereon toward said downstream end.

3. The apparatus of claim 2, wherein said dispensing means includes a dispensing nozzle positioned between said upstream and downstream ends, said moving means including first moving means for moving a shell from said upstream end to a location past said dispensing nozzle.

4. The apparatus of claim 3, wherein said moving means includes second moving means for moving a shell received from said first moving means adjacent said location to said downstream end.

5. The apparatus of claim 4, wherein said first moving means includes a first conveyor belt; and wherein said second moving means includes a second conveyor belt.

6. The apparatus of claim 5, wherein said first and second conveyor belts are positioned side-by-side with respect to each other, each of said first and second conveyor belts extending generally in an axial direction and positioned between said upstream and downstream ends.

7. The apparatus of claim 6, wherein said rolling means includes a bias belt suspended above said first and second conveyor belts for engaging and rolling a shell positioned between said bias belt and at least one of said first and second conveyor belts.

8. The apparatus of claim 7, wherein said bias belt traverses said first and second conveyor belts at an angle such that a shell positioned below said bias belt is caused to roll while moving toward said downstream end.

9. The apparatus of claim 8, wherein said bias belt is movably mounted on said supporting structure such that the angular orientation of said bias belt relative to said first and second conveyor belts is adjustable.

10. The apparatus of claim 9, wherein said rolling means includes first rotating means for rotating said first and second conveyor belts and second rotating means for rotating said bias belt.

11. The apparatus of claim 10, wherein said first rotating means includes a first rotor engaging said first conveyor belt, a second rotor engaging said second conveyor belt and a first motor for rotating said first and second rotors; wherein said second rotating means includes a third rotor engaging said bias belt and a second motor for rotating said third rotor.

12. The apparatus of claim 7, wherein said bias belt is pivotally supported on said supporting structure such that said bias belt is movable between a first position, in which it is suspended above said first and second conveyor belts, and a second position, in which it is pivoted away from said first and second conveyor belts.

13. The apparatus of claim 12, wherein said first and second conveyor belts are exposed when said bias belt is in its second position.

14. The apparatus of claim 2, wherein said moving means includes suction means for applying suction against a shell placed thereon.

15. The apparatus of claim 14, wherein said moving means includes a conveyor belt, said suction means including a plurality of perforations formed in said conveyor belt and a vacuum plenum positioned so as to apply suction against a shell placed on said conveyor belt through at least some of said perforations.

16. The apparatus of claim 2, wherein said rolling means includes curling means for curling an edge of a shell so as to facilitate the formation of said roll.

17. The apparatus of claim 16, wherein said moving means includes a conveyor belt movable along an axial direction, said curling means including a plow positioned on said supporting structure at a location along a side of said conveyor belt.

18. The apparatus of claim 17, wherein said plow includes a wire sized and shaped so as to engage an edge of a shell passing thereby.

19. The apparatus of claim 18, wherein said dispensing means includes a nozzle having a body which is positioned on said supporting structure above said conveyor belt.

20. The apparatus of claim 19, wherein said body is sized and shaped so as to cooperate with said wire to curl an edge of a shell passing thereby.

21. The apparatus of claim 20, wherein said plow includes a plow cover positioned downstream from said wire, said plow cover forming a tunnel therebelow for receiving an edge of a shell curled by said wire and said body.

22. The apparatus of claim 1, further comprising sensing means for sensing the presence of a shell so as to activate said dispensing means.

23. The apparatus of claim 1, further comprising applying means for applying an adhesive material onto an edge of a shell.

24. Apparatus for making rolled food products, comprising a supporting structure having upstream and downstream ends; a dispensing nozzle positioned on said supporting structure between said upstream and downstream ends for dispensing edible filling materials onto a shell passing thereby; at least one conveyor belt positioned on said supporting structure for moving a shell placed thereon toward said downstream end; and a bias belt positioned above said at least one conveyor belt for rolling a shell placed between said bias belt and said at least one conveyor.

25. The apparatus of claim 24, wherein said at least one conveyor belts includes a first conveyor belt and a second conveyor belt positioned side-by-side with respect to each other.

26. The apparatus of claim 27, wherein each of said first and second conveyor belts extends generally in an axial direction and positioned between said upstream and downstream ends.

27. The apparatus of claim 26, wherein said bias belt traverses said first and second conveyor belts at an angle such that a shell positioned below said bias belt is caused to roll while moving toward said downstream end.

28. The apparatus of claim 27, further comprising a plow positioned on said supporting structure at a location along a side of said first conveyor belt for curing an edge of a shell passing thereby.

29. The apparatus of claim 28, wherein said plow includes a wire sized and shaped so as to engage an edge of a shell passing thereby, said dispensing nozzle having a body positioned on said supporting structure above said first conveyor belt, said body being sized and shaped so as to cooperate with said wire to curl an edge of a shell passing thereby.

30. The apparatus of claim 29, wherein said plow includes a plow cover positioned downstream from said wire, said plow cover forming a tunnel therebelow for receiving an edge of a shell curled by said wire and said body.
